(19) United States
(12) Patent Application Publication
(10) Pub. No.: US 2011/0310017 A1
(43) Pub. Date: Dec. 22, 2011

(54) COMPUTER SYSTEM, MOUSE, AND AUTOMATICALLY SHIFTING METHOD THEREOF

(75) Inventors: ZHENG-HAO CHU, Shenzhen City (CN); RUI-YING ZHANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/889,540

(22) Filed: Sep. 24, 2010

(30) Foreign Application Priority Data
Jun. 18, 2010 (CN) 201010203437.7

(51) Int. Cl. G06F 3/033

(52) U.S. Cl. 345/163

(57) ABSTRACT

A computer system includes a mouse and a computer for selecting a left-handed mode and a right-handed mode as a current operation mode of the mouse. When a right hand operates the mouse, the mouse automatically generates a first mode-setting signal, and the computer shifts the current operation mode to the right-handed mode according to the first mode-setting signal. When a left hand operates the mouse, the mouse automatically generates a second mode-setting signal different from the first mode-setting signal, and the computer shifts the current operation mode to the left-handed mode according to the second mode-setting signal.

### BACKGROUND

1. Technical Field

The present disclosure relates to a computer system, and especially to a computer system with a mouse capable of automatically shifting between a right-handed mode and a left-handed mode.

2. Description of Related Art

A computer mouse as an input device of a computer generally has two operation modes; a right-handed mode, and a left-handed mode. People usually use the right hand to operate the mouse, thus the right-handed mode is a default operation mode of the computer mouse. A common method to switch the mouse between the left-handed mode and the right-handed mode is by software such as the control panel of the WINDOWS Operating System. However, left-handed people or people who need to shift the operation mode frequently, it is inconvenient and troublesome.

Therefore, there is room for improvement in the art.

### BRIEF DESCRIPTION OF THE DRAWINGS

The components of the drawings are not necessarily drawn to scale, the emphasis instead being placed upon clearly illustrating the principles of the embodiments of a computer system with a mouse adapted for use by persons either right-handed or left-handed, and a mouse with a method for automatically shifting current operation mode. Moreover, in the drawings, like reference numerals designate corresponding parts throughout the views.

FIG. 1 is a functional block diagram of a computer system according to an exemplary embodiment, including a mouse.

FIG. 2 is an isometric, schematic view of the mouse of FIG. 1.

FIG. 3 is a functional block diagram of a computer system according to another exemplary embodiment, including a mouse.

FIG. 4 is an isometric, schematic view of the mouse of FIG. 3.

FIG. 5 is a flowchart of a method for shifting an operation mode of a mouse according to an exemplary embodiment.

FIG. 6 is a flowchart of a method for shifting an operation mode of a mouse according to another exemplary embodiment.

### DETAILED DESCRIPTION

Embodiments of the present disclosure will now be described in detail with reference to the drawings.

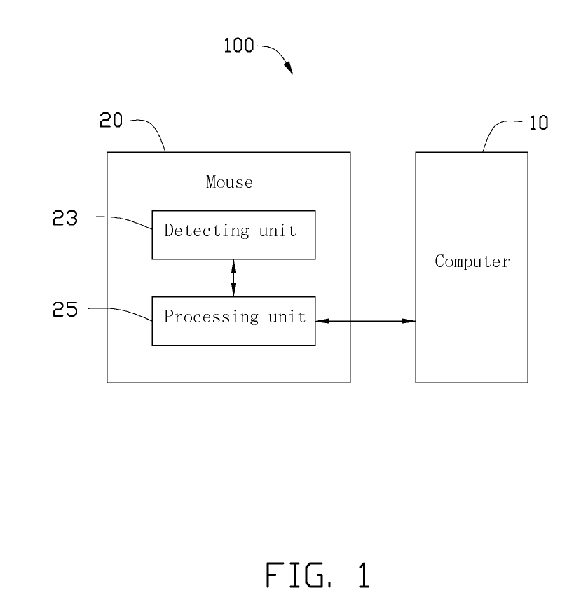

Referring to FIG. 1, a computer system 100 according to an exemplary embodiment is illustrated. In this embodiment, the computer system 100 includes a computer 10 and a mouse 20 attached to the computer 10. In this embodiment, the mouse 20 is a wired mouse, and communicates with the computer 10 by a cable. In other embodiments, the mouse 20 can be a wireless mouse, and communicates with the computer 10 by electromagnetic waves.

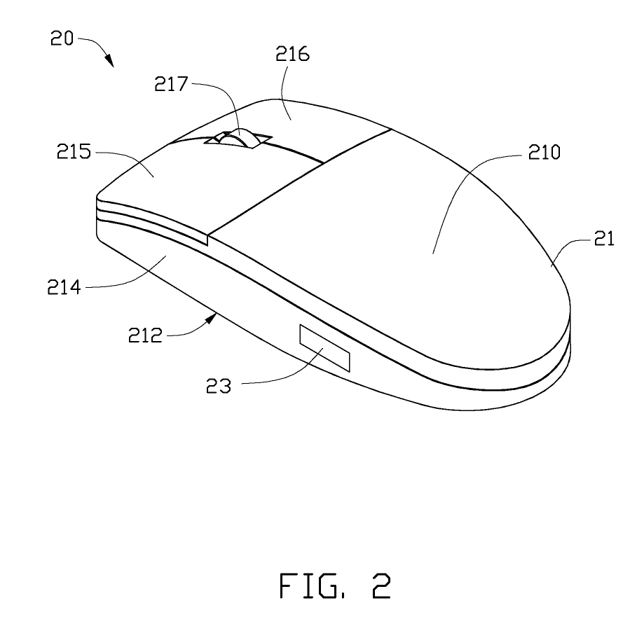

Further referring to FIG. 2, the mouse 20 includes a housing 21, a detecting unit 23 mounted on the housing 21, and a processing unit 25 received in the housing 21.

The housing 21 defines a top surface 210, a bottom surface 212 opposite to the top surface 210, and a side surface 214 connecting the top surface 210 and the bottom surface 212. The mouse 20 further includes a left-button 215, a right-button 216 aligned with the left-button 215, and a wheel 217. The left-button 215, the right-button 216, and the wheel 217 are mounted on the top surface 210. The left-button 215 and the right-button 216 are provided for responding to user's click operations to generating controlling signals, such as a single click operation or a double click operation. The wheel 217 is located between the left-button 215 and the right-button 216, and is surrounded by the left-button 215 and the right-button 216.

The detecting unit 23 is used for being touched, and further for generating a touch signal when it is touched for a predetermined time. In this embodiment, the detecting unit 23 is a touch sensor. The detecting unit 23 is mounted on the side surface 214 which is near the left-button 215. For example, the detecting unit 23 is mounted on the middle of the side surface 214 to be suitable for common use. When a user uses the mouse 20 with a right hand, a thumb of the right hand touches the detecting unit 23.

The processing unit 25 is used for determining whether the detecting unit 23 receives the touch signal, and further for generating a first mode-setting signal when it receives the touch signal. However, if the processing unit 25 does not receive the touch signal, for example, the touch signal is not generated by the detecting unit 23, the processing unit 25 further determines whether the computer 10 is responding to controlling signals of the mouse 20. If the computer 10 is responding to the controlling signals of the mouse 20, the processing unit 25 generates a second mode-setting signal. Thus, the processing unit 25 can recognize the hand operating the mouse 20 is a right hand or is a left hand, and generate the first mode-setting signal and the second mode-setting signal accordingly.

The computer 10 shifts a current operation mode of the mouse 20 according to the first mode-setting signal and the second mode-setting signal. The current operation mode is stored in the computer 10, and operation modes of the mouse 20 include a left-handed mode and a right-handed mode. In this embodiment, the first mode-setting signal represents the right-handed mode, and the second mode-setting signal represents the left-handed mode.

The computer 10 determines which mode is the current operation mode of the mouse 20. If it is determined that the current operation mode of the mouse 20 is the left-handed mode, the computer 10 shifts the current operation mode to the right-handed mode according to the first mode-setting signal, otherwise, the computer 10 keeps the current operation mode. If it is determined that the current operation mode of the mouse 20 is the right-handed mode, the computer 10 shifts the current operation mode to the left-handed mode according to the second mode-setting signal, otherwise, the computer 10 keeps the current operation mode.

As discussed above, the computer system 100 is convenient for people to switch the operation mode to operate the mouse 20 either left-handed or right-handed.

In other embodiments, the detecting unit 23 can be mounted on the side surface 214 which is near the right-button 216. When the user uses the mouse 20 with a left hand, a thumb of the left hand can mostly touches the detecting unit 23. When the detecting unit 23 is touched for the predetermined time, the detecting unit 23 generates the touch signal. Thus, the first mode-setting signal represents the left-handed mode, and the second mode-setting signal represents the right-handed mode.

In other embodiments, the detecting unit 23 can include two touch sensors. One touch sensor is mounted on the side surface 214 which is near the left-button 215, and is for generating a first touch signal when it is touched for the predetermined time. The other touch sensor is mounted on the side surface 214 which is near the right-button 216, and is for generating a second touch signal when it is touched for the predetermined time. The processing unit 25 generates a first mode-setting signal according to the first touch signal, and a second mode-setting signal according to the second touch signal. The first mode-setting signal represents the left-handed mode, and the second mode-setting signal represents the right-handed mode.

In other embodiments, the computer system 100 can further include an indicator (not shown) set on the mouse 20, such as a LED. The indicator lamp is used for indicating the current operation mode of the computer system 100. For example, the indicator lamp is turned on when the computer system 100 is in the left-handed mode, the indicator lamp is turned off when the computer system 100 is in the right-handed mode. Thus, it is convenient for people to recognize the current operation mode of the computer system 100.

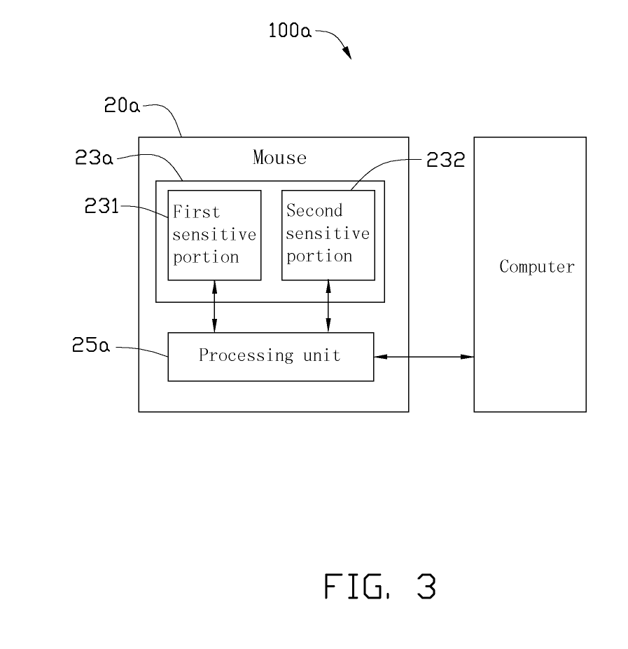

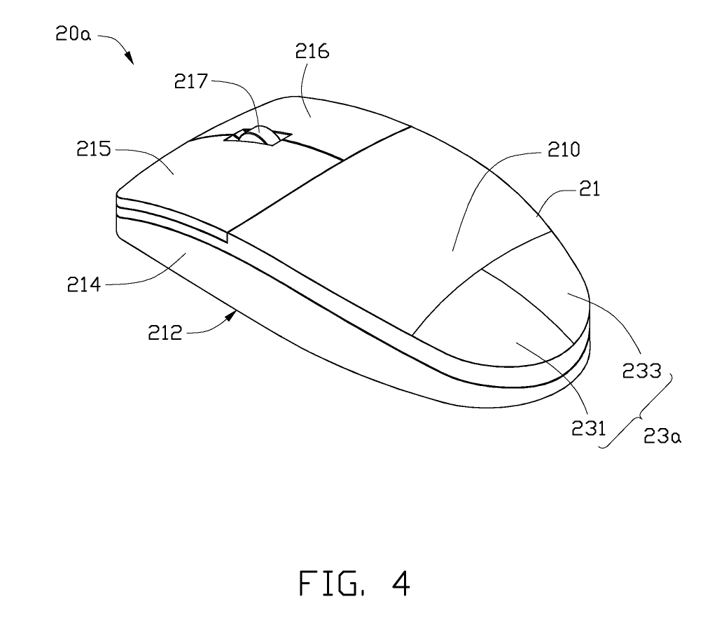

Referring to FIGS. 3 and 4, another computer system 100a according to another exemplary embodiment is illustrated. The difference between the two computer systems 100 and 100a is described as follow.

The detecting unit 23a of the computer system 100a is a pressure sensor, and is used for detecting pressure forced on thereof. The detecting unit 23a is mounted on an end of the top surface 210 which is opposite to the left-button 215 and the right-button 216. The detecting unit 23a includes a first sensitive portion 231 and a second sensitive portion 233 aligned with the first sensitive portion 231. The first sensitive portion 231 is on the top surface 210 at the side of the left-button 215, and is used for generating a first pressure value when a forced is applied thereon. The second sensitive portion 233 is on the top surface 210 with at the side of the right-button 216, and is used for generating a second pressure value when a forced is applied thereon.

As commonly used, when the user operates the mouse 20a of the computer system 100a by a hand, the first sensitive portion 231 and the second sensitive portion 233 will be pressed by the hand. The thumb of the hand touches the side surface 214, and the little finger touches a support plane which holds the mouse 20a, such as a desk. Thus, the hand is declined to the support plane, and the first sensitive portion 231 and the second sensitive portion 233 get different pressure values. When the mouse 20a is operated by a right hand, the first pressure value of the first sensitive portion 231 is smaller than the second pressure value of the second sensitive portion 233, and when the mouse 20a is operated by a left hand, the first pressure value of the first sensitive portion 231 is greater than the second pressure value of the second sensitive portion 233.

The processing unit 25a of the computer system 100a is used for determining a relationship between the first pressure value and the second pressure value. When the first pressure value is smaller than the second pressure value, the processing unit 25a generates a first mode-setting signal. When the first pressure value is greater than the second pressure value, the processing unit 25a generates a second mode-setting signal. Thus, the computer 10 can update a current operation mode of the mouse 20 according to the first mode-setting signal and the second mode-setting signal.

The computer system 100a has the similar advantage of the computer system 100.

In other embodiments, the detecting unit can include both a touch sensor and a pressure sensor. Thus, the judgment of the computer system about which hand operates the mouse will be more precise.

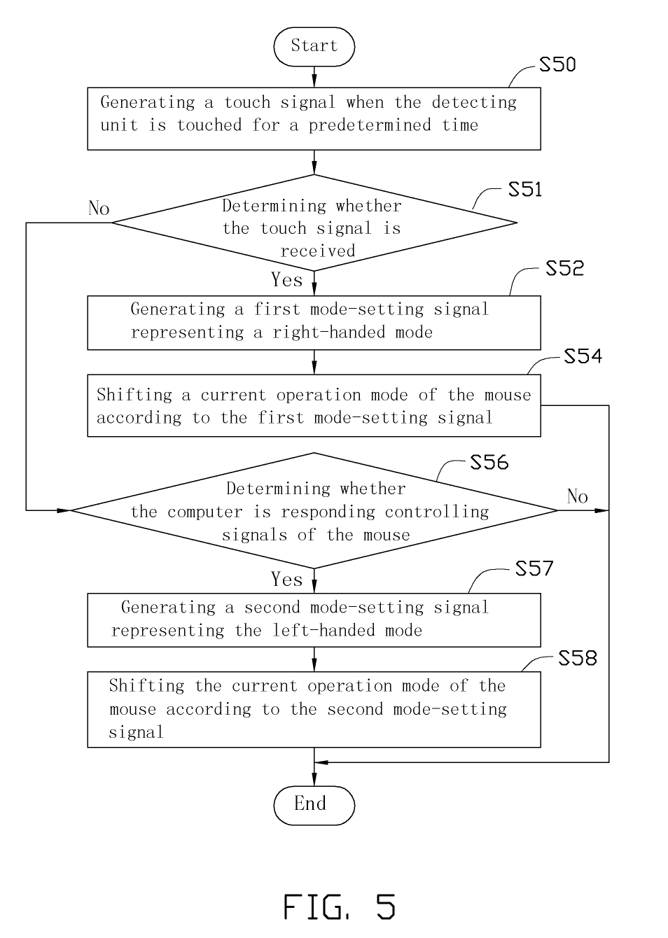

Referring to FIG. 5, a method for automatically shifting an operation mode of a mouse 20 of the computer system 100 is illustrated. The shifting method shown includes the following steps.

In step S50, generating a touch signal when the detecting unit 23 is touched for a predetermined time.

In step S51, determining whether the touch signal is received. If yes, the process goes to step S52, if no, the process goes to step S56.

In step S52, generating a first mode-setting signal representing a right-handed mode if it is determined that the touch signal is received.

In step S54, shifting a current operation mode of the mouse 20 according to the first mode-setting signal.

In step S56, determining whether the computer 10 is responding to controlling signals of the mouse 20 if the touch signal is not generated. If yes, the process goes to step S57, if no, the process goes to end.

In step S57, generating a second mode-setting signal representing the left-handed mode if it is determined that the computer 10 is responding to the controlling signals of the mouse 20.

In step S58, shifting the current operation mode of the mouse 20 according to the second mode-setting signal.

In steps S54 and S58, the computer 10 further determines which mode is the current operation mode of the mouse 20. If it is determined that the current operation mode of the mouse 20 is the left-handed mode, the computer 10 shifts the current operation mode to the right-handed mode according to the first mode-setting signal, otherwise, the computer 10 keeps the current operation mode. If it is determined that the current operation mode of the mouse 20 is the right-handed mode, the computer 10 shifts the current operation mode to the left-handed mode according to the second mode-setting signal, otherwise, the computer 10 keeps the current operation mode.

Thus, this method for automatically shifting an operation mode of a mouse 20 of the computer system 100 is convenient for people to switch the operation mode to operate the mouse either left hand or right hand.

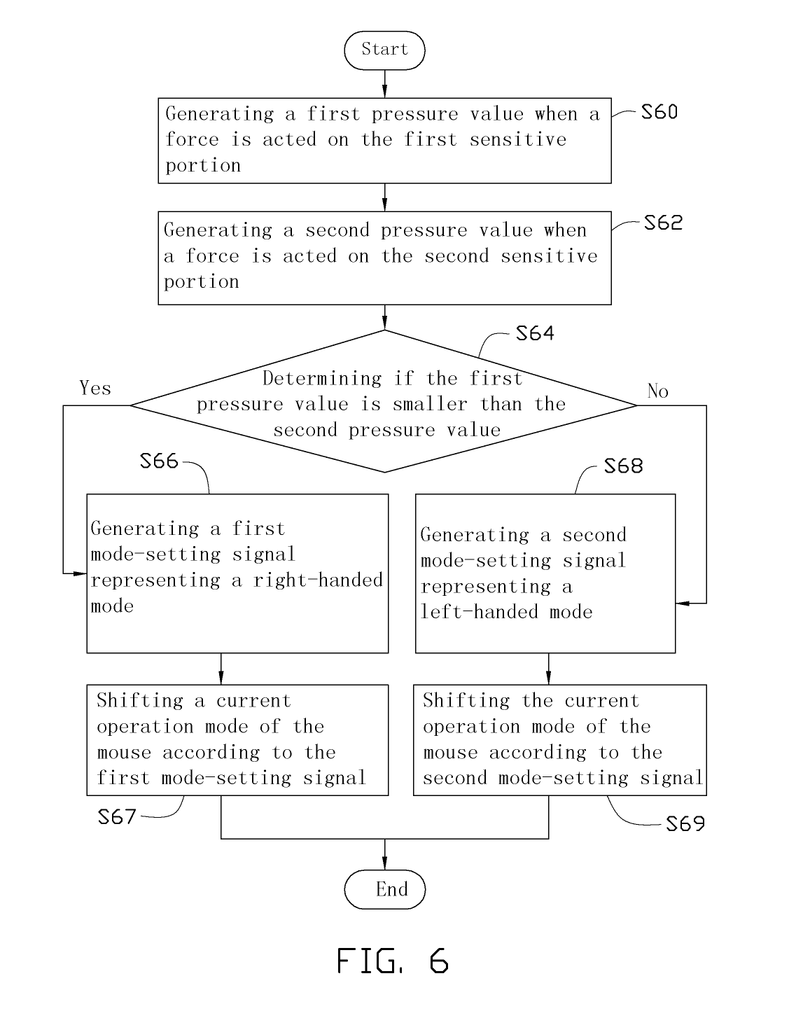

Referring to FIG. 6, another method for automatically shifting an operation mode of a mouse 20a of the computer system 100a is illustrated. The shifting method shown includes the following steps.

In step S60, generating a first pressure value when a force is acted on the first sensitive portion 231.

In step S62, generating a second pressure value when a force is acted on the second sensitive portion 233.

In step S64, determining if the first pressure value is smaller than the second pressure value. If yes, step S66 is performed, if no, step S68 is performed.

In step S66, generating a first mode-setting signal representing a right-handed mode if it is determined that the first pressure value is smaller than the second pressure value.

In step S67, shifting a current operation mode of the mouse 20 according to the first mode-setting signal.

In step S68, generating a second mode-setting signal representing a left-handed mode if it is determined that the first pressure value is greater than the second pressure value.

In step S69, shifting the current operation mode of the mouse 20 according to the second mode-setting signal.

In steps S67 and S69, the computer 10 further determines which mode is the current operation mode of the mouse 20. If it is determined that the current operation mode of the mouse 20 is the left-handed mode, the computer 10 shifts the current operation mode to the right-handed mode according to the first mode-setting signal, otherwise, the computer 10 keeps the current operation mode. If it is determined that the current operation mode of the mouse 20 is the right-handed mode, the computer 10 shifts the current operation mode to the left-handed mode according to the second mode-setting signal, otherwise, the computer 10 keeps the current operation mode.

Thus, this method for automatically shifting an operation mode of a mouse 20a of the computer system 100a is convenient for people to switch the operation mode to operate the mouse either left hand or right hand.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation to encompass all such modifications and similar arrangements.

What is claimed is:

1. A computer system, comprising:
a mouse; and
a computer for selecting a left-handed mode and a right-handed mode as a current operation mode of the mouse which is attached to the computer;
wherein, when a right hand operates the mouse, the mouse automatically generates a first mode-setting signal, and the computer shifts the current operation mode to the right-handed mode according to the first mode-setting signal, when a left hand operates the mouse, the mouse automatically generates a second mode-setting signal different from the first mode-setting signal, and the computer shifts the current operation mode to the left-handed mode according to the second mode-setting signal.

2. The computer system of claim 1, wherein the computer determines which mode is the current operation mode of the mouse, if it is determined that the current operation mode of the mouse is the left-handed mode, the computer shifts the current operation mode to the right-handed mode according to the first mode-setting signal, if it is determined that the current operation mode of the mouse is the right-handed mode, the computer shifts the current operation mode to the left-handed mode according to the second mode-setting signal.

3. The computer system of claim 1, wherein the mouse comprises a detecting unit and a processing unit, the detecting unit is for detecting a hand operating the mouse is a left hand or a right hand, the processing unit is for generating the first mode-setting signal when the detecting unit detects the right hand and further for generating the second mode-setting signal when the detecting unit detects the left hand.

4. The computer system of claim 3, wherein the mouse further comprises a housing, a left-button, and a right-button aligned with the left-button, the detecting unit is mounted on the housing, and the processing unit is received inside of the housing, the housing defines a top surface, a bottom surface opposite to the top surface, and a side surface connecting the top surface and the bottom surface.

5. The computer system of claim 4, wherein the detecting unit is mounted on the side surface and is near the left-button, the detecting unit is for being touched, and further for generating a touch signal when it is touched for a predetermined time, the processing unit generates the first mode-setting signal if receives the touch signal.

6. The computer system of claim 5, wherein if the processing unit does not receive the touch signal, the processing unit determines whether the computer is responding to controlling signals of the mouse, if the computer is responding to the controlling signals of the mouse, the processing unit further generates the second mode-setting signal.

7. The computer system of claim 4, wherein the detecting unit comprises a first sensitive portion and a second sensitive portion aligned with the first sensitive portion, the first sensitive portion is on the top surface with the left-button and is used for generating a first pressure value when a forced is applied thereon, the second sensitive portion is on the top surface with the right-button and is used for generating a second pressure value when a forced is applied thereon, a relationship is defined by the first pressure value and the second pressure value, the processing unit generates the first mode-setting signal and the second mode-setting signal according to the relationship.

8. The computer system of claim 7, wherein when the first pressure value is smaller than the second pressure value, the processing unit generates the first mode-setting signal representing the right-handed mode.

9. The computer system of claim 7, wherein when the first pressure value is greater than the second pressure value, the processing unit generates the second mode-setting signal representing the left-handed mode.

10. A mouse responding to one of a left-handed mode and a right-handed mode as a current operation mode of a computer system, the mouse comprising:
a detecting unit for detecting a hand operating the mouse is a left hand or a right hand; and
a processing unit for generating a first mode-setting signal when the detecting unit detects the right hand, and further for generating a second mode-setting signal when the detecting unit detects the left hand, the first mode-setting signal for shifting the current operation mode to the right-handed mode, the second mode-setting signal different from the first mode-setting signal and for shifting the current operation mode to the left-handed mode.

11. The mouse of claim 10, wherein the detecting unit is mounted on a side surface of the mouse and is near a left-button of the mouse, the detecting unit is for being touched, and further for generating a touch signal when it is touched for a predetermined time, the processing unit generates the first mode-setting signal when it receives the touch signal.

12. The mouse of claim 11, wherein when the mouse is operating and the touch signal can not be generated by the detecting unit, the processing unit generates the second mode-setting signal.

13. The mouse of claim 10, wherein the mouse further comprises a left-button and a right-button aligned with the left-button, the detecting unit is mounted on a top surface and is opposite to the left-button and the right-button, the detecting unit comprises a first sensitive portion and a second sensitive portion aligned with the first sensitive portion, the first sensitive portion is on the top surface with the left-button and is used for generating a first pressure value when a forced is applied thereon, the second sensitive portion is on the top surface with the right-button, and is used for generating a second pressure value when a forced is applied thereon, a relationship is defined by the first pressure value and the second pressure value, the processing unit generates the first mode-setting signal and the second mode-setting signal according to the relationship.

14. The mouse of claim 13, wherein when the first pressure value is smaller than the second pressure value, the processing unit generates the first mode-setting signal representing the right-handed mode.

15. The mouse of claim 13, wherein when the first pressure value is greater than the second pressure value, the processing unit generates the second mode-setting signal representing the left-handed mode.

16. A method for automatically shifting one of a left-handed mode and a right-handed mode as a current operation mode of a mouse of a computer system, the method comprising:
when a hand is operating the mouse, automatically detecting whether the hand is a left hand or a right hand;
generating a first mode-setting signal when the right hand is identified;
shifting the current operation mode of the mouse according to the first mode-setting signal;
generating a second mode-setting signal when the left hand is identified; and
shifting the current operation mode of the mouse according to the second mode-setting signal.

17. The method of claim 16, further comprising:
determining whether the left-hand or the right-hand is the current operation mode of the mouse;
if it is determined that the current operation mode of the mouse is the left-handed mode, shifting the current operation mode to the right-handed mode according to the first mode-setting signal; and
if it is determined that the current operation mode of the mouse is the right-handed mode, shifting the current operation mode to the left-handed mode according to the second mode-setting signal.

18. The method of claim 16, wherein the mouse further comprises a detecting unit for being touched, and further for generating a touch signal when it is touched for a predetermined time, the method further comprises:
generating the touch signal when the detecting unit is touched for the predetermined time;
generating the first mode-setting signal according to the touch signal;
determining whether the computer is responding to controlling signals of the mouse if the touch signal is not generated; and
generating the second mode-setting signal if the computer is responding to the controlling signals of the mouse.

19. The method of claim 16, wherein the mouse further comprises two detecting units mounted on two opposite sides of the mouse, one detecting unit is for generating a first touch signal when it is touched for a predetermined time, the other touch sensor is for generating a second touch signal when it is touched for the predetermined time, the method further comprises:
generating the first touch signal when the corresponding detecting unit is touched for the predetermined time;
generating the first mode-setting signal according to the first touch signal;
generating the second touch signal when the corresponding detecting unit is touched for the predetermined time; and
generating the second mode-setting signal according to the second touch signal.

20. The method of claim 16, wherein the mouse further comprises a left-button and a right-button aligned with the left-button, the detecting unit comprises a first sensitive portion and a second sensitive portion aligned with the first sensitive portion, the first sensitive portion is with the side of the left-button and is used for generating a first pressure value when a forced is applied thereon, the second sensitive portion is with the side of the right-button and is used for generating a second pressure value when a forced is applied thereon, the method further comprises:
generating the first pressure value when a force is acted on the first sensitive portion;
generating the second pressure value when a force is acted on the second sensitive portion;
determining a relationship between the first pressure value and the second pressure value;
generating the first mode-setting signal representing the right-handed mode if it is determined that the first pressure value is smaller than the second pressure value; and
generating the second mode-setting signal representing the left-handed mode if it is determined that the first pressure value is greater than the second pressure value.
